(19) United States
(12) Patent Application Publication
(10) Pub. No.: US 2013/0271952 A1
(43) Pub. Date: Oct. 17, 2013

(54) LED Backlight Source

(71) Applicants: Kuangyao Chang, Shenzhen (CN); Chong Xiong, Shenzhen (CN)

(72) Inventors: Kuangyao Chang, Shenzhen (CN); Chong Xiong, Shenzhen (CN)

(73) Assignee: Shenzhen China Star Optoelectronics Technology Co. LTD., Shenzhen City, Guangdong (CN)

(21) Appl. No.: 13/520,568

(22) PCT Filed: Apr. 18, 2012
(86) PCT No.: PCT/CN12/74230

§ 371 Date: Jul. 4, 2012

(30) Foreign Application Priority Data
Apr. 11, 2012 (CN) 201210104450.6

(51) Int. Cl. G09F 13/04; F21V 9/16

(52) U.S. Cl. 362/84

(57) ABSTRACT

The present invention provides an LED backlight source, which includes a printed circuit board, a plurality of LED lights mounted to and electrically connected to the printed circuit board, an LED lens mounted to the printed circuit board, and fluorescent powder. The LED lens is set above and covers the plurality of LED lights. Each of the LED lights includes a carrier frame, a light-emitting chip mounted in the carrier frame, and an encapsulation resin that encapsulates the light-emitting chip in the carrier frame. The fluorescent powder is mounted to the LED lens. The present invention provides an LED backlight source, which arranges fluorescent powder and encapsulation resin in a separate manner so as to realize adjustability of chromaticity of the LED lights chromaticity and improve yield rate of manufacture.

### BACKGROUND OF THE INVENTION

1. Field of the Invention

The present invention relates to the field of liquid crystal displaying, and in particular to an LED (Light-Emitting Diode) backlight source.

2. The Related Arts

Liquid crystal display (LCD) has a variety of advantages, such as compact device size, low power consumption, and being free of radiation, and is thus widely used. Most of the LCDs that are currently available in the market are backlighting LCDs, which comprise a liquid crystal panel and a backlight module. The working principle of the liquid crystal panel is that liquid crystal molecules are interposed between two parallel glass substrates and a plurality of vertical and horizontal fine electrical wires is arranged between the two glass substrates, whereby the liquid crystal molecules are controlled to change direction by application of electricity in order to refract light emitting from the backlight module for generating images. Since the liquid crystal display panel itself does not emit light, light must be provided by the backlight module in order to normally display images. Thus, the backlight module is one of the key components of an LCD. The backlight module often uses LED light bars as a backlight source and correspondingly, the LED light bars that are used in the backlight module are also referred to as LED backlight sources.

A conventional LED backlight source comprises a printed circuit board and a plurality of LED lights that is mounted to and electrically connected to the printed circuit board. A conventional LED light (see FIG. 1) comprise a carrier frame 100, a light-emitting chip 200 mounted in the carrier frame 100, and an encapsulation rein 300 that encapsulates the light-emitting chip 200 in the carrier frame 100. To increase light intensity of the LED light, fluorescent powders 400 are often mixed in the encapsulation resin 300. However, such a structure makes the fluorescent powders 400 very close to the light-emitting chip 200 so that the luminous efficiency of the fluorescent powders 400 is affected by the heat generated by the light-emitting chip 200. As shown in FIG. 2, curves of the relationship between luminous efficiency and temperature are given for five commonly used fluorescent powders, wherein the compositions of the fluorescent powders are respectively silicate (SrBaSiO₄:Eu), yttrium aluminum garnet (Y₃Al₅O₁₂:Ce), (Y.Gd)₃Al₅O₁₂:Ce, and red and green nitrides.

After encapsulation of the light-emitting chip 200, chromaticity of the LED light must be inspected for classification purposes. However, since the fluorescent powders 400 are mixed in the encapsulation resin 300, it is generally not possible to adjust the chromaticity of the LED light after the encapsulation. Those LED lights that are disqualified for chromaticity must be treated as wastes and this deteriorates the yield rate of the LED lights and makes the cost high.

### SUMMARY OF THE INVENTION

An object of the present invention is to provide an LED backlight source, which has a simple structure, high luminous intensity, high adjustability of chromaticity, and low cost.

To achieve the object, the present invention provides an LED backlight source, which comprises a printed circuit board, a plurality of LED lights mounted to and electrically connected to the printed circuit board, an LED lens mounted to the printed circuit board, and fluorescent powder. The LED lens is set above and covers the plurality of LED lights. Each of the LED lights comprises a carrier frame, a light-emitting chip mounted in the carrier frame, and an encapsulation resin that encapsulates the light-emitting chip in the carrier frame. The fluorescent powder is mounted to the LED lens.

The LED lens comprises a lens body and mounting tabs extending from two sides of the lens body. The lens body comprises an inner surface opposing the LED lights and an outer surface opposite to the inner surface. The inner surface of the lens body forms a curved recess that opposes the LED lights. The outer surface comprises two symmetric curved faces.

The fluorescent powder is in the form of particulates that are uniformly distributed in the lens body of the LED lens.

Alternatively, the fluorescent powder is in the form of particulates that are uniformly distributed on an outer surface of the lens body of the LED lens.

Alternatively, the fluorescent powder is in the form of particulates that are uniformly distributed on a surface of the curved recess of the lens body of the LED lens.

Alternatively, the fluorescent powder is in the form of a membrane structure that is contained in the lens body of the LED lens to be exactly located above the LED lights.

Alternatively, the fluorescent powder is in the form of a membrane structure that is attached to a surface of the curved recess of the lens body of the LED lens.

The carrier frame comprises a chassis and anode and cathode copper foils mounted in the chassis. The anode and cathode copper foils extend out of the chassis to respectively form a negative lead and a positive lead. The anode and cathode copper foils are respectively and electrically connected by two gold wires to the light-emitting chip.

The light-emitting chip is fixed by means of adhesive to the anode copper foil.

The efficacy of the present invention is that the present invention provides an LED backlight source, which arranges fluorescent powder and encapsulation resin in a separate manner so as to realize adjustability of chromaticity of the LED lights chromaticity and improve yield rate of manufacture. Further, since the fluorescent powder and the light-emitting chip are spaced from each other, the influence of the heat generated by the light-emitting chip on the luminous efficiency of the fluorescent powder is alleviated to thereby improve the overall luminous intensity of the LED backlight source.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is a schematic view showing the structure of a conventional LED light;

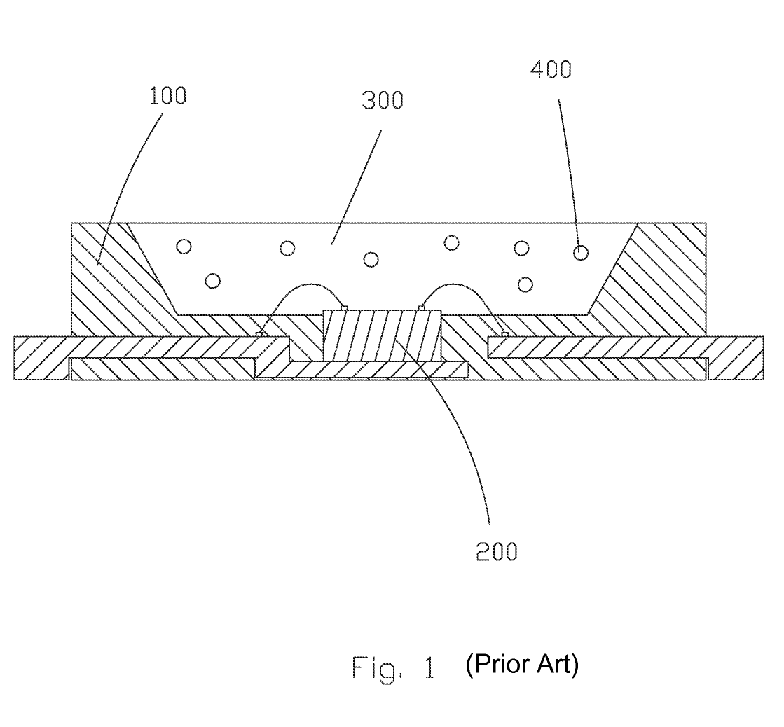

FIG. 2 shows curves of relationship between luminous efficiency and temperature for five commonly used fluorescent powders;

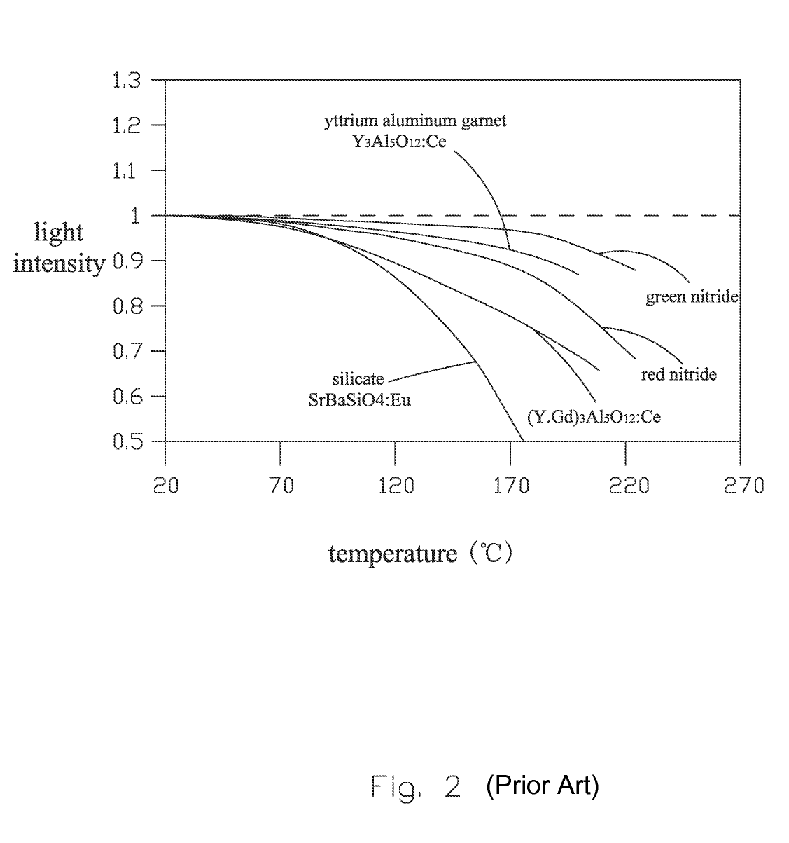

FIG. 3 is a schematic view showing the structure of an LED backlight source according to a first embodiment of the present invention;

FIG. 4 is a schematic view showing the structure of an LED backlight source according to a second embodiment of the present invention;

FIG. 5 is a schematic view showing the structure of an LED backlight source according to a third embodiment of the present invention;

FIG. 6 is a schematic view showing the structure of an LED backlight source according to a fourth embodiment of the present invention; and

FIG. 7 is a schematic view showing the structure of an LED backlight source according to a fifth embodiment of the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

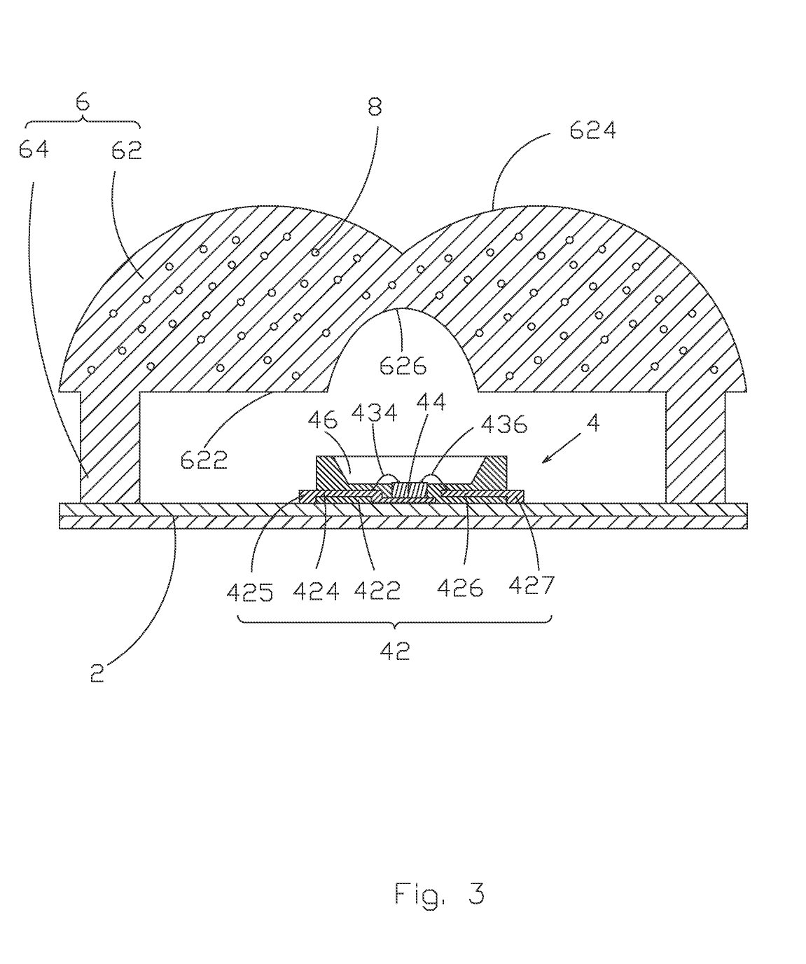

Referring to FIG. 3, the present invention provides an LED (Light-Emitting Diode) backlight source, which comprises a printed circuit board 2, a plurality of LED lights 4 mounted to and electrically connected to the printed circuit board 2, an LED lens 6 mounted to the printed circuit board 2, and fluorescent powder 8. The LED lens 6 is set above and covers the plurality of LED lights 4. The LED lights 4 emit lights that transmit through the LED lens 6 to emit out in a bat-like fashion so as to reduce the distance for light mixture and thus facilitate thinning of backlight module (not shown).

Each of the LED lights 4 comprises a carrier frame 42, a light-emitting chip 44 mounted in the carrier frame 42, and an encapsulation resin 46 that encapsulates the light-emitting chip 44 in the carrier frame 42. The fluorescent powder 8 is mounted to the LED lens 6.

The LED lens 6 comprises a lens body 62 and mounting tabs 64 extending from two sides of the lens body 62. The lens body 62 comprises an inner surface 622 opposing the LED lights 4 and an outer surface 624 opposite to the inner surface 622. The inner surface 622 of the lens body 62 forms a curved recess 626 that opposes the LED lights 4. The outer surface 624 comprises two symmetric curved faces. The LED lens 6 is mounted by the mounting tabs 64 to the printed circuit board 2 to completely cover the LED lights 4. The LED lens 6 comprises the fluorescent powder 8 mounted thereto. In the instant embodiment, the fluorescent powder 8 is in the form of particulates uniformly distributed in the lens body 62 of the LED lens 6. Since the fluorescent powder 8 is mounted to the LED lens 6, adjustability of chromaticity of the LED lights 4 is generally not affected by the encapsulation of the LED lights 4. Waste can thus be reduced. Meanwhile, the fluorescent powder 8 is set distant from the light-emitting chip 44, and the influence of the heat generated by the light-emitting chip 44 on the luminous efficiency of the fluorescent powder 8 can be alleviated to thereby improve overall luminous intensity of the LED backlight source.

The carrier frame 42 comprises a chassis 422 and anode and cathode copper foils 424, 426 mounted in the chassis 422. The anode and cathode copper foils 424, 426 both extend out of the chassis 422 to respectively form a negative lead 425 and a positive lead 427. The anode and cathode copper foils 424, 426 are respectively and electrically connected by two gold wires 434, 436 to the light-emitting chip 44. Since the light-emitting chip 44 cannot be directly mounted to the chassis 422, the known solutions are to first mount the light-emitting chip 44 to the anode or cathode copper foil 424, 426 and then to fix the anode and cathode copper foils 424, 426 in the chassis 422 to thereby fix the light-emitting chip 44 to the carrier frame 42. In the instant embodiment, the light-emitting chip 44 is fixed by means of adhesive to the anode copper foil 424.

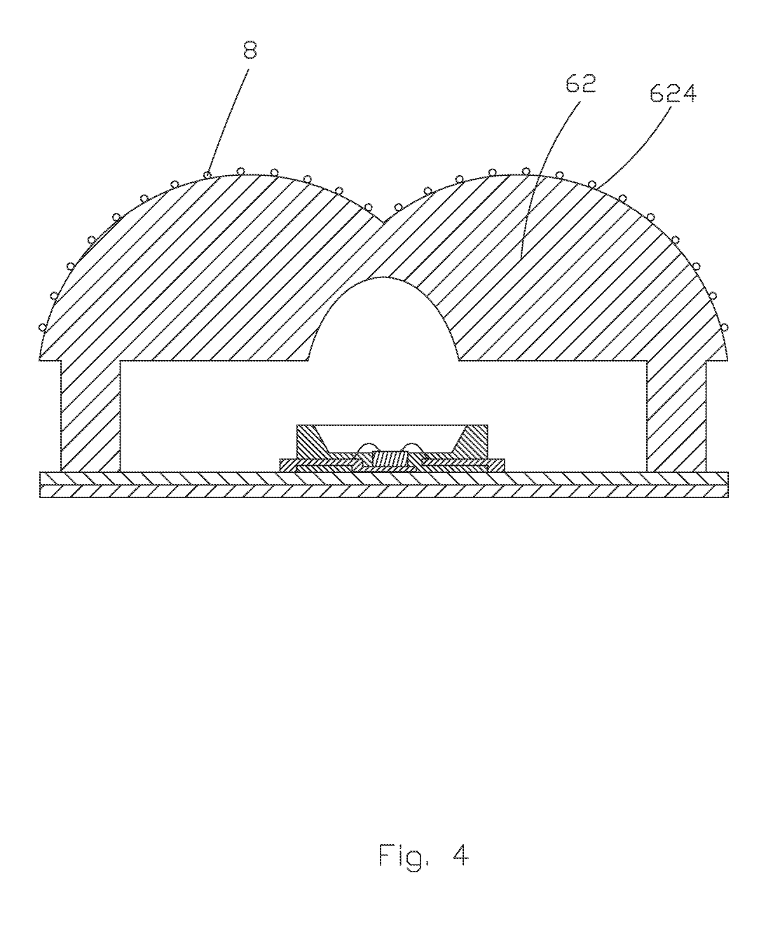

Referring to FIG. 4, which is a schematic view showing the structure of LED backlight source according to a second embodiment of the present invention, in the instant embodiment, the fluorescent powder 8 is in the form of particulates that are uniformly distributed on an outer surface 624 of the lens body 62 of the LED lens 6.

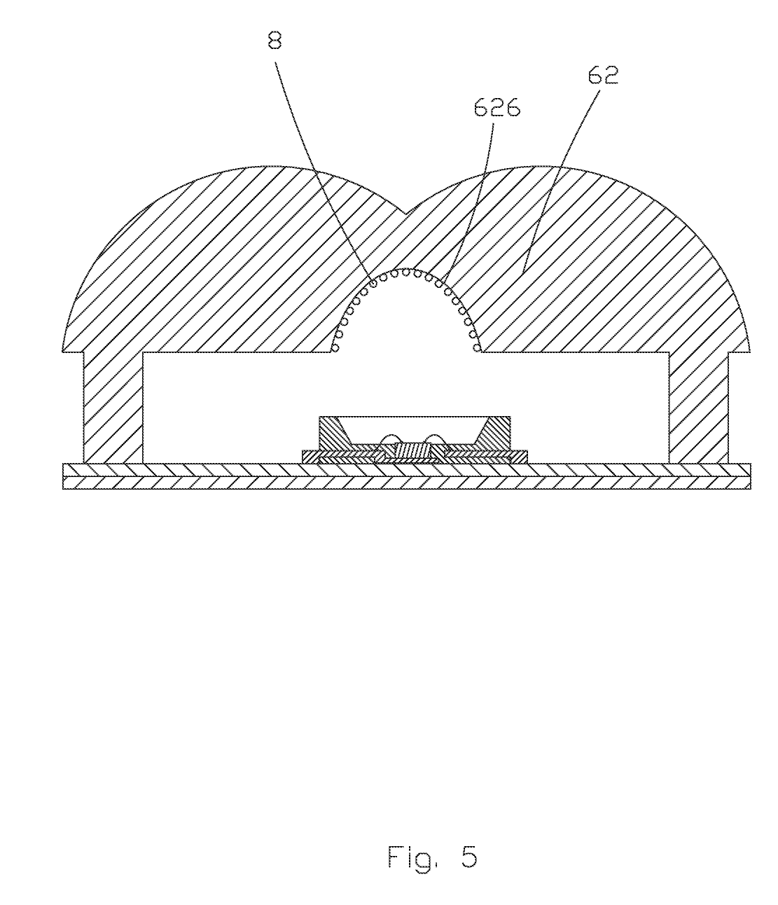

Referring to FIG. 5, which is a schematic view showing the structure of LED backlight source according to a third embodiment of the present invention, in the instant embodiment, the fluorescent powder 8 is in the form of particulates that are uniformly distributed on a surface of the curved recess 626 of the lens body 62 of the LED lens 6.

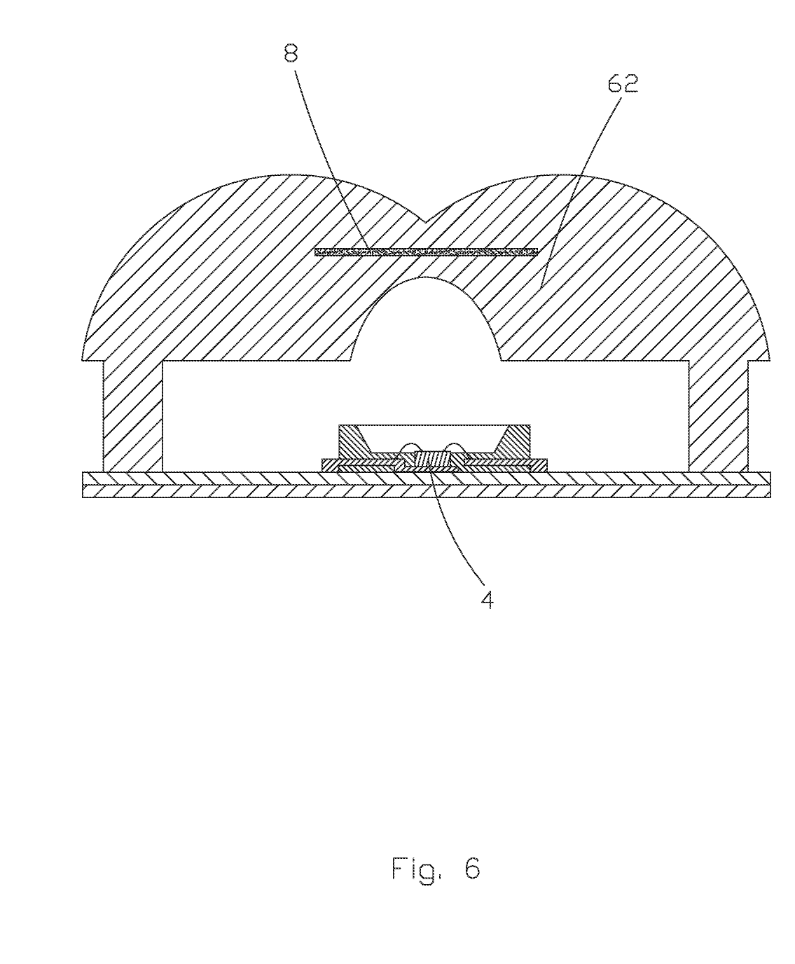

Referring to FIG. 6, which is a schematic view showing the structure of LED backlight source according to a fourth embodiment of the present invention, in the instant embodiment, the fluorescent powder 8 is in the form of a membrane structure that is contained in the lens body 62 of the LED lens 6 to be exactly located above the LED lights 4.

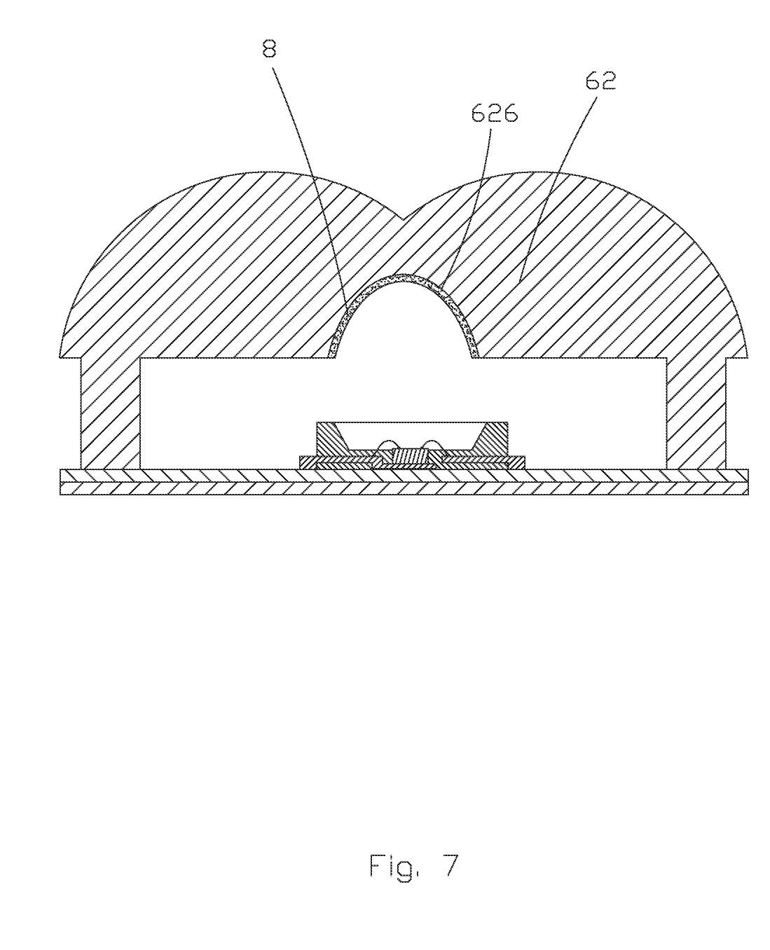

Referring to FIG. 7, which is a schematic view showing the structure of LED backlight source according to a fifth embodiment of the present invention, in the instant embodiment, the fluorescent powder 8 is in the form of a membrane structure that is attached to a surface of the curved recess 626 of the lens body 62 of the LED lens 6.

The present invention provides an LED backlight source, which arranges fluorescent powder and encapsulation resin in a separate manner so as to realize adjustability of chromaticity of the LED lights chromaticity and improve yield rate of manufacture. Further, since the fluorescent powder and the light-emitting chip are spaced from each other, the influence of the heat generated by the light-emitting chip on the luminous efficiency of the fluorescent powder is alleviated to thereby improve the overall luminous intensity of the LED backlight source.

Based on the description given above, those having ordinary skills of the art may easily contemplate various changes and modifications of the technical solution and technical ideas of the present invention and all these changes and modifications are considered within the protection scope of right for the present invention.

What is claimed is:

1. An LED (Light-Emitting Diode) backlight source, comprising a printed circuit board, a plurality of LED lights mounted to and electrically connected to the printed circuit board, an LED lens mounted to the printed circuit board, and fluorescent powder, the LED lens being set above and covering the plurality of LED lights, each of the LED lights comprising a carrier frame, a light-emitting chip mounted in the carrier frame, and an encapsulation resin that encapsulates the light-emitting chip in the carrier frame, the fluorescent powder being mounted to the LED lens.

2. The LED backlight source as claimed claim 1, wherein the LED lens comprises a lens body and mounting tabs extending from two sides of the lens body, the lens body comprising an inner surface opposing the LED lights and an outer surface opposite to the inner surface, the inner surface of the lens body forming a curved recess that opposes the LED lights, the outer surface comprising two symmetric curved faces.

3. The LED backlight source as claimed claim 2, wherein the fluorescent powder is in the form of particulates that are uniformly distributed in the lens body of the LED lens.

4. The LED backlight source as claimed claim 2, wherein the fluorescent powder is in the form of particulates that are uniformly distributed on an outer surface of the lens body of the LED lens.

5. The LED backlight source as claimed claim 2, wherein the fluorescent powder is in the form of particulates that are uniformly distributed on a surface of the curved recess of the lens body of the LED lens.

6. The LED backlight source as claimed claim 2, wherein the fluorescent powder is in the form of a membrane structure that is contained in the lens body of the LED lens to be exactly located above the LED lights.

7. The LED backlight source as claimed claim 2, wherein the fluorescent powder is in the form of a membrane structure that is attached to a surface of the curved recess of the lens body of the LED lens.

8. The LED backlight source as claimed claim 1, wherein the carrier frame comprises a chassis and anode and cathode copper foils mounted in the chassis, the anode and cathode copper foils extending out of the chassis to respectively form a negative lead and a positive lead, the anode and cathode copper foils being respectively and electrically connected by two gold wires to the light-emitting chip.

9. The LED backlight source as claimed claim 8, wherein the light-emitting chip is fixed by means of adhesive to the anode copper foil.

10. An LED (Light-Emitting Diode) backlight source, comprising a printed circuit board, a plurality of LED lights mounted to and electrically connected to the printed circuit board, an LED lens mounted to the printed circuit board, and fluorescent powder, the LED lens being set above and covering the plurality of LED lights, each of the LED lights comprising a carrier frame, a light-emitting chip mounted in the carrier frame, and an encapsulation resin that encapsulates the light-emitting chip in the carrier frame, the fluorescent powder being mounted to the LED lens;
wherein the LED lens comprises a lens body and mounting tabs extending from two sides of the lens body, the lens body comprising an inner surface opposing the LED lights and an outer surface opposite to the inner surface, the inner surface of the lens body forming a curved recess that opposes the LED lights, the outer surface comprising two symmetric curved faces;
wherein the fluorescent powder is in the form of particulates that are uniformly distributed in the lens body of the LED lens;
wherein the carrier frame comprises a chassis and anode and cathode copper foils mounted in the chassis, the anode and cathode copper foils extending out of the chassis to respectively form a negative lead and a positive lead, the anode and cathode copper foils being respectively and electrically connected by two gold wires to the light-emitting chip; and
wherein the light-emitting chip is fixed by means of adhesive to the anode copper foil.
